(19) United States
(12) Patent Application Publication
(10) Pub. No.: US 2008/0281631 A1
(43) Pub. Date: Nov. 13, 2008

(54) Health Information Management System

(76) Inventors: Linda H. Syth, Oregon, WI (US); Susan Turney, Madison, WI (US)

Correspondence Address: WHYTE HIRSCHBOECK DUDEK S.C., 33 East Main Street, Suite 300, Madison, WI, 53703-4655, US

(21) Appl. No.: 12/062,474

(22) Filed: Apr. 3, 2008

Related U.S. Application Data
(60) Provisional application No. 60/909,737, filed on Apr. 3, 2007.

(51) Int. Cl. G06Q 10/00

(52) U.S. Cl. 705/2

(57) ABSTRACT

A novel healthcare data management system is provided which brings together various types of healthcare related data for enhanced patient care and overall patient data management. In one aspect of the invention a relational database is utilized for merging and managing healthcare provider demographic data, patient healthcare data, and administrative data.

### CROSS REFERENCE TO RELATED APPLICATIONS

This application claims priority to U.S. Provisional Application Ser. No. 60/909,737, filed Apr. 3, 2007, which is fully incorporated by reference herein.

### BACKGROUND OF THE INVENTION

The utilization of health care services has increased from 8% of the United States gross national product (GNP) to 16% of the GNP over tile past several years. Health care related expenses are expected to rise and the demand for health care services will grow exponentially as the population ages over the next 20 years, particularly in response to the aging baby boom generation. Given the trend for utilization of health care services, it is conceivable that the use of health care services could exceed 20 percent of the GNP at some point in the future. According to Mark Leavitt, the Secretary of Health and Human Services, in a speech on Mar. 7, 2007, the economy becomes unstable if any one sector of the US economy exceeds 20 percent of the GNP. Without dramatic change health care could create instability in the US economy.

The US employer-provided health care system has suffered a tremendous burden due to government-provided (Medicare and Medicaid) health care programs paying less than the true cost of services provided. The shortfall for many years has been shifted onto the private payer system known as the “hidden tax.” Businesses are no longer willing or able to support those shifting expenses. The US needs to stabilize health care costs so they can compete in today's global market.

An accurate physician demographic database has the significant potential for creating a robust, accurate quality and cost efficiency database for use with health care. In order to be effective, the physician data should be matched up with patient claim data in a way that maximizes a high percent of useable data points. The patient-physician relationship is a symbiotic relationship that is at its best when patients and physicians are working together to manage a patient's care along with influencing the health system in which they are operating. Over time, it would be advantageous for a health data management system to revolutionize health care by improving quality, reducing costs and improving the health care payment system, while providing transparency and accountability.

It would be advantageous to provide a health care information management system that can collect and manage various types of data to improve health care and organizational efficiency, improve quality, manage medical practice risks by reducing errors and scientific standards; and provide a means for public reporting and public access to data. Cat least one embodiment of the present invention includes the collection and verification of physician demographic data, patient demographic data, claims data, quality data and risk management protocols.

### BRIEF DESCRIPTION OF THE DRAWINGS

Preferred embodiments of the invention are described below with reference to the following accompanying drawings, which are for illustrative purposes only. Throughout the following views, reference numerals will be used in the drawings, and the same reference numerals will be used throughout the several views and in the description to indicate same or like parts.

FIG. 1 is a schematic illustrating an information management system in accordance with at least one embodiment of the present invention.

FIG. 2 is a schematic illustrating an alternative form of the information management system in accordance with at least one embodiment of the present invention.

### DETAILED DESCRIPTION

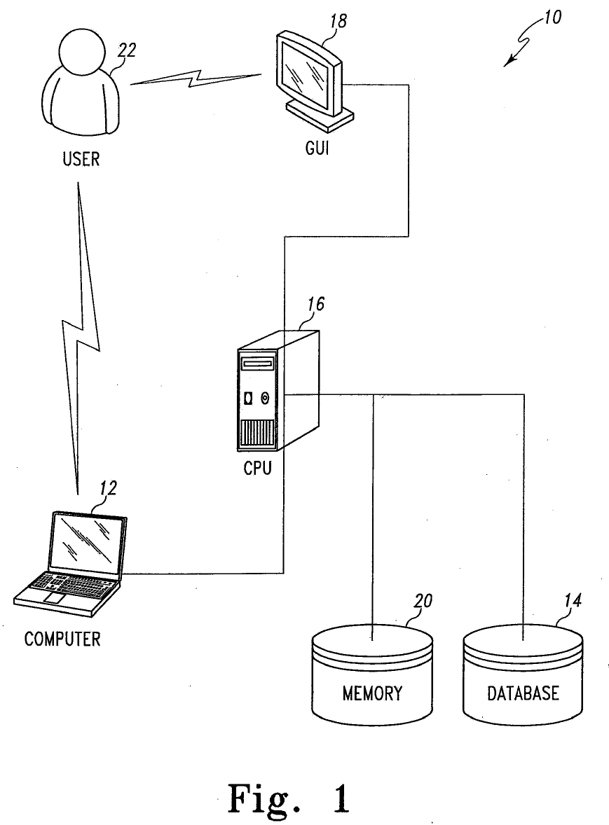

Briefly, in at least one aspect of the invention, a health care management system 10 is provided in FIG. 1. The system 10 includes a computing device 12, a database 14, a central processing unit 16, a graphical user interface 18, and a memory storage device 20. A user 22 can access the system 10 through the GUI 18 or computing device 12. The central processing unit is operatively connected to a relational database configured to manage healthcare related data. The memory storage unit 20 is operatively connected to the database 14, wherein the healthcare related data comprises healthcare provided demographic data, administrative data, and clinical data. The user interface 18 is used to access the database 14. Alternatively, the elements of the system 10 can be connected through the Internet, rather than through a direct hardwire connection. By example, the database 14 can be located in a separate physical location from the GUI 18, in such a circumstance the database 14 and GUT 18 are connected via the Internet. A physician is a healthcare provider.

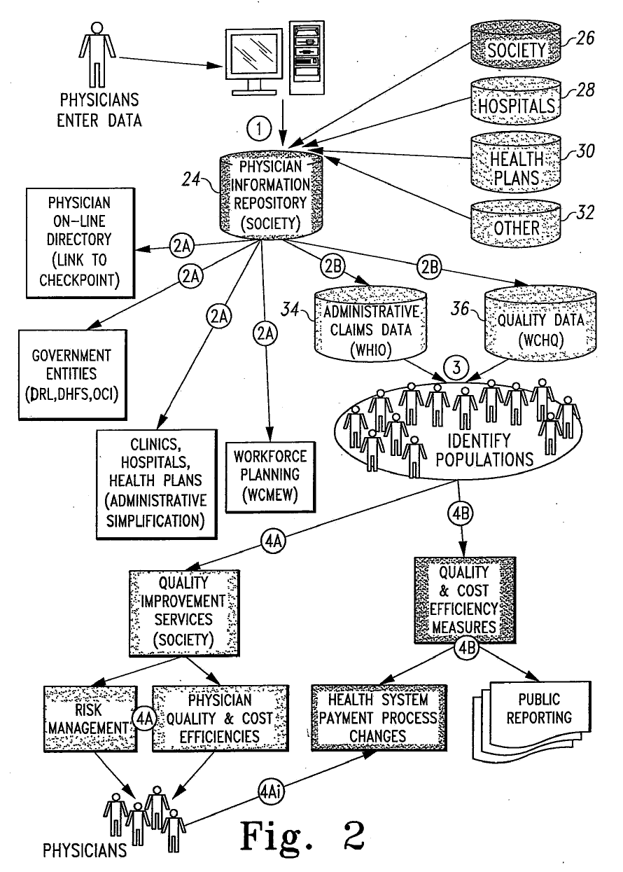

The database 14 includes a robust healthcare provider information repository 24 (FIG. 2), the data associated with the repository 24 is stored within memory 20. The system 10 includes a means for sharing data elements from the information repository 24 with a number of governmental agencies, hospitals, health plans, and the public and claims and quality reporting entities. Furthermore, the system 10 allows users, by example physicians or healthcare administrators, to combine administrative data with, quality data to improve patient safety and provide effective, patient-centered, timely, equitable and efficient health care to all patients. Administrative and quality data are compared with national quality measures to develop relevant quality improvement services that help users, such as physicians, to minimize risks associated with patient care, while increasing quality. This part of the system 10 will also use the data to create positive changes in the health care payment process and ensure public reporting of meaningful data. Public reporting can help patients, payors, and government make meaningful choices about health care based on demographics, quality and cost. In at least one embodiment, the various forms of data are connected to the repository 24 through separate databases 26, 28, 30, 32, 34, 36.

The system 10 merges physician involvement at the beginning of the process, the data entry stage, with physician involvement with the creation, collection and reporting of other types of data to achieve high quality patient care, efficiency and accountability. The system 10 ensures that patient care remains the central focus of all aspects of data collection and management.

### Data Input and Verification

An administrative user can coordinate with physician users to enter and certify their own physician demographic data into the physician information repository. Alternatively, the physician or medical related data can be dynamically updated to the repository. The system allows users to enter various data elements into the system. The system will continuously update data with other relevant sources such as hospital, health plan and some government agencies. The software provides physicians with a user-friendly method of updating and certifying demographic data. The System will carry the history going forward on all of these elements to connect a physician to claims data points over time. The demographic data will include elements common to the credentialing process (Exhibit 2).

Healthcare providers, such as physicians, have a significant incentive to participate in the data process because the compilation of accurate information into a single database would be very useful to many areas of physician practice, such as credentialing, preparing insurance forms and decreasing administrative costs of the medical practice.

As a result, the embodiments of the present invention provide a distinct advantage as compared to other data management systems. The systems can collect physician demographic information, and other medical-related data, from other sources such as hospitals, health plans and governmental agencies. Today, various entities, hospitals, workforce planning groups, government entities and others collect physician demographic information in separate databases. Some of the data collecting entities use each other's information to update and verify their own databases. Fees or dues by physicians support all of these databases. The majority of the information contained in the various databases is similar. Some of the information is redundant, some is inaccurate and some of the information is collected in a manner that limits its use to the particular purpose for which it is collected by the entity.

In one aspect the system uses a multi-tier process to ensure that physician demographic data is highly accurate and that it does not appear multiple times in the information repository 24. Most databases have multiple entries for a single physician (e.g. John Smith, John P. Smith, J. P. Smith, MD. etc.). In such cases, it is often difficult to determine whether there are multiple people with similar names or simply multiple entries for the same person. Because of the confusion, multiple entries reduce the information's utility and limit the potential for sharing data. The information repository 24 collects the information from multiple sources, verifies it, and distills it into useable data elements, for the ultimate purpose of improving quality and efficiency so that physicians provide better patient care. Data input for the system is selected from the following illustrative, but not exhaustive list: Physician name, physician license number, national provider identifier, date of birth, home address, clinic address, medical school, Medical school graduation information (date and any distinctions), residency program information, board certification, areas of practice, specialty (even if not board certified), gender, race, fellowship information, clinical experience, military experience, work history, professional liability information and claim status, and professional references.

### Data Sharing

The System 10 provides a methodology for sharing physician demographic data with other entities. Data sharing and connectivity between the physician information repository and data management systems, or other entities such as clinics, hospitals, health plans, workforce planning agencies and claims and quality reporting, is contemplated. Data sharing among entities can create efficiencies, including but not limited to, the following: Eliminate data entry duplication, decrease the cost of maintaining separate databases, allow for other organizations to focus their IT resources on their unique needs, decrease new license application time, make physician information easily available to the public in one spot.

The data-sharing component of the system 10 will improve physician workforce planning efforts by merging verified, physician demographic data with workforce plans designed to prevent physician workforce shortages and ensure high quality health care in all Wisconsin communities.

### Combining Administrative and Clinical Data Sets

The physician repository can provide users the ability to do, by example, the following without access to electronic records:

Update and transfer their physician demographic data

Load and transfer their claims data

Clinically manage their patient populations

Analyze the care their patients are receiving against physician established scientific benchmarks

Manage risk for both patients and the practice by establishing a process that ensures patients are encouraged and reminded to follow scientific evidence-based guidelines

In another aspect, the system provides healthcare providers who don't have access to electronic medical records to use further features of the system to manage the diagnosed patients in a more transparent, accessible way. Patient demographics, diagnoses and clinical information can be maintained confidentially from this portal in a patient population manager/repository.

Along with updating healthcare provider information, a means, such as a clearinghouse, is available to upload electronic claims for processing, Members and partners using this means agree their claims will be:

1. Grouped in meaningful episodes of care (i.e. hip replacement)

2. Available to link clinical data to the care event

3. Aggregated and de-identified to look for opportunities to improve population health

4. Combine clinical and administrative data analyzed for payment methodologies that support safe, effective, patient-centered, timely, efficient and equitable health care to all.

It is important to use patient populations or groups to study and manage diseases and ultimately improve the quality of health care. Healthcare provider work groups dedicated to various areas, such as asthma, diabetes, low back pain and acute myocardial infarction to mine claims data to find a specific healthcare provider's patient population for the diagnosis code of interest can be created. Clinical data can be obtained through chart review.

Chart reviews can be performed to mine the clinical data. Patient demographics, diagnoses and clinical information will be maintained confidentially from this portal in a patient population manager/repository. Clinical/quality data is in the patient repository 24 and physician developed scientific measures such as those developed by the AMA Physician Consortium can be used to help physicians evaluate how their patient population is doing against the scientific benchmark.

### Development of Quality Improvement Services and Cost Effective Measures

At least one embodiment of the present invention pairs administrative data with clinical data, which can help improve patient care when patients are attributed to the proper physician for care surrounding a patient diagnosis that has been grouped together in a rational way. The real opportunity is when the clinical results are matched to the actual services provided and analyzed based on provider-detailed scientific measures. The System provides significant opportunities to physicians and clinics to use data to provide cost effective, high quality patient care.

There is no single type of data that can provide the means of increasing quality while reducing costs. Administrative data is often the focus of discussion but does not produce reliable quality health care results until merged together with clinical data into a means for managing the data, such as various embodiments of the present invention. Administrative Data is often considered the infrastructure the current health system is built on. The major source of data is the data contained on a HCFA (Health Care Financing Administration) 1500 form. Major data elements required on the form are provider, patient and payment data. Patient demographic data—subject to strict state and federal privacy rules—contain information such as sex, race, age and address. Claims data is collected from the billing process. For a provider to get paid for the service rendered they must identify the patient, the health care professional that provided the services, what services were provided and why. For example, patient X was seen by Dr. Y to review the diabetic patient's lab results and to adjust medicine, exercise and diet efforts to manage the diabetes. Claims data doesn't provide actual results of the lab tests, which is essential to improving patient health. The System recognizes the shortfalls of the various data systems when used in isolation and combines them in a rational method to produce optimal results.

In recent years, an industry, spurred by business' desire to decrease costs, has blossomed analyzing claims data to find ways to make outpatient care more cost efficient. Efforts have been hindered by inadequate sample sizes; inaccurate data and process transparency leading to minimal physician buy in. Data input can include physician user direct involvement to achieve cost efficiencies and increased quality. Therefore, it is likely to be more successful than other initiatives. Physician users are provided with direct support through the system 10 which enhances the productivity and ability to extract data from physicians.

This data can be used in two more interrelated ways. First, studies show that patients trust their physicians to hold the patient personal health record/information. The patient population manager, which is part of the System, is designed to allow the patient access and portability of their personal health record (PHR). The second effort will be to use all the information gained to educate patients. Using the PHR instructions can be outlined clearly on diet, medication, exercise, frequency of glucose testing etc to provide optimal care based on the scientific measures and evidence-based guidelines.

This dynamic, scientific-based process can help practices appropriately manage risk such as medical negligence and insurance billing issues. Medical liability carriers have expressed interest in methods that systematically manage risk. A reduction in medical liability claims is expected when physicians use a system to appropriately manage patient populations and document that patient care is based on nationally accepted scientific health care standards. This process data is available for healthcare providers to share with their medical liability carriers. The System also provides an opportunity to identify the basis for a new medical liability system that continues to support injured patients but doesn't create disincentives to coordinated safe, effective, patient-centered, timely, efficient and equitable health care to all.

Ambulatory/outpatient health care delivery has two main types of data—administrative and clinical data. Administrative data includes patient and physician demographic information and claims/payment information. Clinical data includes visit notes, lab and diagnostic results. Each of these sets of data provides a glimpse into the care provided in the United States. However, the ability to use data in practical manner to improve patient outcomes is the point at which data intersects. Efforts to capitalize on the types of data are just beginning. The System maximizes its relationship with physicians to harness this intersecting data to provide safe, effective, patient-centered, timely, efficient and equitable health care to all.

The System merges electronic health records and/or physician demographic information for licensing, credentialing and insuring into a single System to achieve a cohesive method of providing better care to patients, while achieving cost and administrative efficiencies.

Referring to FIG. 2, the system 10 is shown in a data flow diagram. At step 1 physician demographic data is collected in one central repository referred to as the physician information repository. Data can be collected from a medical society, hospitals, health plans or other health care entities. At step 2A, identified system users can gain access to the repository. Availability of the information is advantageous for reducing unnecessary duplication, resulting in administrative simplification, by example. System users can include workforce planning, clinics, hospitals, health plans, government entities, and physicians. Repository data and administrative claims data are combined at step 2B. The episode of care methodology is applied to combined data to examine quality and cost efficiency in varying demographic populations.

User engagement is shown at step 4A. Data is accessible by various users dependent upon access privileges set by a system administrator. By example, physicians can initiate quality control and improvement in their medical or health related practices. A risk management assessment tool and educational tools are provided. Such tools provide users with data analysis and quality improvement for system data, which is advantageous, by example, for cost efficiency. At step 4B, quality improvement measures provide key data for affecting health car system changes and aggregate-level public reporting.

An alternative embodiment of the repository or physician data warehouse is provided. This embodiment provides a means for storing governmental and personal health related information available to all users with access. The repository is an Internet-based solution designed to decrease costs within both private and public user groups. Physicians and health related professionals have access to data about themselves, including their patient data.

It is specifically intended that the present invention not be limited to the embodiments and illustrations contained herein, but include modified forms of those embodiments including portions of the embodiments and combinations of elements of different embodiments as come within the scope of the following claims.

1. An information management system comprising:
a central processing unit operatively connected to a relational database configured to manage healthcare related data;
a memory storage unit operatively connected to the relational database, wherein the healthcare related data comprises healthcare provided demographic data, administrative data, and clinical data; and
a user interface for accessing-the relational database.

2. The system according to claim 1, wherein the administrative data is selected from a group consisting of patient related claims data and healthcare related payment data.

3. The system according to claim 1, wherein the database is configured to manage disease populations.

4. The system according to claim 1, wherein the database is configured to develop health care related cost efficiencies.

5. The system according to claim 1, wherein the interface is Internet based.

6. The system according to claim 1, wherein the healthcare provider data is selected from a group consisting of provider name, physician license number, national provider identifier, date of birth, home address, clinic address, medical school, medical school graduation information, residences program information, board certification, areas of practice, provider specialty, gender, race, fellowship information, clinical experience, military experience, work history, professional liability information and claim status, and professional references.

7. The system according to claim 1, wherein electronic health records are merged with physician demographic data, the database configured to achieve a cohesive method of providing better care to patients, while achieving cost and administrative efficiencies.

8. A health information management system comprising:
a physician information repository;
a risk management analysis module for accessing healthcare patient related risk; and
a means for identifying a health related population; and
a relational database configured to manage physician demographic data, administrative data, and clinical data.
